(19) United States
(12) Patent Application Publication
(10) Pub. No.: US 2005/0127215 A1
(43) Pub. Date: Jun. 16, 2005

(54) Device for comminuting agglomerates, in particular by breaking up microparticles by piston movement in a container

(75) Inventors: Hermann Lienhart, Uttenreuth (DE); Franz Durst, Langensendelbach (DE); Ozgur Ertunc, Erlangen (DE); Leonid Terentiev, Erlangen (DE); Rolf Laube, Weilheim (DE)

Correspondence Address: MCDONNELL BOEHNEN HULBERT & BERGHOFF LLP, 300 SOUTH WACKER DRIVE, SUITE 3200, CHICAGO, IL, 60606, US

(73) Assignee: Roche Diagnostics Operations, Inc.

(21) Appl. No.: 10/997,438

(22) Filed: Nov. 23, 2004

(30) Foreign Application Priority Data
Nov. 24, 2003 (DE) 103 54 904.8

(51) Int. Cl. B02C 17/16

(52) U.S. Cl. 241/21; 241/172

(57) ABSTRACT

A device for comminuting agglomerates of particles in a suspension is described. The device has a container for receiving the suspension and at least one piston which can be moved in the container in particular in a reciprocating manner in order to move a suspension between two spatial regions of a cylinder chamber of the container, the two spatial regions being connected together by at least one flow path for the suspension which defines a constriction.

### CROSS REFERENCE

This application claims priority to German patent application DE 103 54 904.8, filed Nov. 24, 2003, which is incorporated by reference herein in its entirety.

### FIELD OF THE INVENTION

The present invention concerns a device for comminuting agglomerates of particles present in a suspension.

### BACKGROUND

Suspensions are used in diverse technical fields and in particular in the chemical field. Thus for example suspensions of microparticles, so-called beads, on whose surfaces capture molecules e.g. DNA are immobilized which can bind with certain analytes of a sample to be examined that can be detected by measuring systems are used for analytical purposes in the medical-diagnostic field. However, in these diagnostic and analytical applications and also in other application fields for suspensions, the problem occurs that the solid microparticles dispersed in the respective liquid form agglomerates. This is caused in particular by electrostatic forces and Van der Waals interactions between the microparticles. Such agglomerates may impair the optimal utilization of the suspension in the respective application.

Devices and methods are known which are intended to counteract the formation of agglomerates and comminute agglomerates that are already present. Conventional mixing devices are used among others for this purpose such as stirrers. Stirring the suspension exerts forces on the agglomerates of microparticles due to the stirring movement which counteract the attractive forces between the microparticles. In particular the stirring movement generates shear flows and these in turn generate shearing forces which act on the agglomerates and reduce the size of the agglomerates.

The previously known devices and methods have the disadvantage that they are not able to comminute agglomerates in suspensions to an adequate extent for certain applications. With the known stirring devices, either very long stirring times have to be accepted or very high stirring rates are necessary. Both of these are disadvantageous for certain applications especially because the time efficiency is low and reagents that are specific to the application which may be bound to the microparticles may become detached from the microparticles by the stirring process.

It is known from the article “Dispersibility of Applied Chemistry” by K. Higashitani, Proceedings of Second World Congress PARTICLE TECHNOLOGY, Sep. 19-22, 1990, Kyoto, Japan, that extensional flows and longitudinal flows with flow acceleration can be used to comminute agglomerates. The hydrodynamic forces acting on the agglomerates as a result of the extensional flows result in a substantially improved comminution of the agglomerates. In order to generate the extensional flows, the suspension should for example be passed through an opening i.e. a constriction in the flow path of the suspension.

Hence the object of the present invention was to provide an improved device compared to the prior art which can be used to more effectively reduce the size of agglomerates in suspensions.

### BRIEF DESCRIPTION OF THE FIGURES

FIGS. 1a and 1b show two snapshots of a schematic side-view of an embodiment of the invention during operation of the device.

FIG. 2a shows a schematic side-view of a second embodiment of the device according to the invention.

FIG. 2b shows a view of the piston of the device from FIG. 2a from below.

FIG. 3a shows a schematic lateral view of a third embodiment.

FIG. 3b shows a view of the piston of the device from FIG. 3a.

FIG. 4 shows a schematic lateral view of a fourth embodiment of the invention.

### DETAILED DESCRIPTION OF THE INVENTION

The device according to the invention for comminuting agglomerates of particles in a suspension comprises a container for receiving the suspension and at least one fluid displacement means preferably in the form of a piston which can be moved in the container in order to move a suspension between two spatial regions of a hollow space arrangement of the container, the two spatial regions being connected together by at least one flow path for the suspension which defines a constriction.

The displacement of the suspension caused by the piston movement results in a strong acceleration of the suspension as it flows through the constriction. In this process the hydrodynamic tensile forces and extending forces that were already mentioned above with reference to the article by K. Higashitani act on the agglomerates in the suspension. This results in an efficient comminution of agglomerates and additionally a thorough mixing of the suspension occurs. A device according to the invention enables the so-called stable state of the smallest possible agglomerates to be reached in a suspension in a relatively short time. A significant further reduction in the size of the agglomerates is then no longer possible with an acceptable amount of effort.

According to a preferred embodiment of the invention, the fluid displacement means is a piston forming a border between the spatial regions which can be moved axially backwards and forwards in a cylinder chamber containing the two spatial regions, which piston can displace the held suspension alternately from one spatial region into the other spatial region through the constriction as it moves backwards and forwards in the cylinder chamber. Such an embodiment of the device according to the invention can be realized and operated in a simple manner. Thus the flow path defining the constriction can be for example formed by a hole which passes axially through the piston. Then when the piston moves in the cylinder chamber, the suspension displaced from the spatial region that becomes smaller can flow through the axial hole in the piston into the expanding spatial region to produce a high flow rate in the area of the constriction and a strong acceleration of the flow having the effect that the agglomerates are torn apart. The resulting turbulence that also occurs in the suspension ensures a rapid transport of particles in the liquid and thus a good mixing or homogenization of the suspension. The reciprocating movement of the piston moves the suspension backwards and forwards between the two spatial regions during which it must each time flow through the constriction since the cylinder chamber is essentially closed towards the outside during the operation of the comminution device.

As a result, the large agglomerates that were originally present are comminuted as far as possible after a relatively short time and are thoroughly mixed. The suspension prepared in this manner can then be removed from the cylinder chamber or from the container through a valve that is opened or such like and provided for the intended use.

According to one embodiment of the invention, a small amount of the suspension is discharged from the container through a very small opening and a corresponding amount of suspension to be treated is introduced into the container through another small opening on each stroke of the piston.

Of course, several small axial holes or such like can be provided in the piston which can form a flow path for the displaced suspension.

According to another embodiment, the flow path defining the constriction is formed by an annular gap between the circumferential wall of the piston and the wall of the cylinder chamber. In such a case it is advisable to movably guide the piston in an axial manner on a piston rod which leads outwards since it is not guided by the circumferential wall of the cylinder chamber.

According to another embodiment, the flow path defining the constriction is formed by at least one radial recess in the circumferential wall of the piston.

Another embodiment of the invention provides that the two spatial regions are connected together by a fluid line forming the flow path of the suspension which runs outside the cylinder chamber. In such a case, the piston can essentially sealingly separate the two spatial regions such that the displaced suspension can only escape from the one spatial region into the other spatial region via the external fluid line.

According to one embodiment of the invention, the piston can be operated manually. In another embodiment of the invention, a drive motor is provided for the reciprocating movement of the piston.

According to a preferred embodiment of the invention, the device for comminuting agglomerates is integrated into an automated analysis system for the chemical analysis of molecules and in particular biomolecules. In such a case, the solid phase of the suspension preferably consists of beads i.e. microparticles with capture molecules immobilized thereon which can specifically bind to analytes of a sample to be analyzed that is added to the suspension e.g. a body fluid of a living being wherein this binding can be detected by technical measuring means of the analytical system such as spectroscopic means.

In this sense, the device according to the invention is very suitable for reducing the size of agglomerates of microparticles (beads) to which medical diagnostic reagents are attached. Especially high demands are made on the suspensions in such medical diagnostic applications, since a reduction in the bindable surface of the beads exposed to the sample material due to agglomerates has to be avoided as far as possible.

### EXAMPLES

Embodiments of the invention are described in the following with reference to the figures.

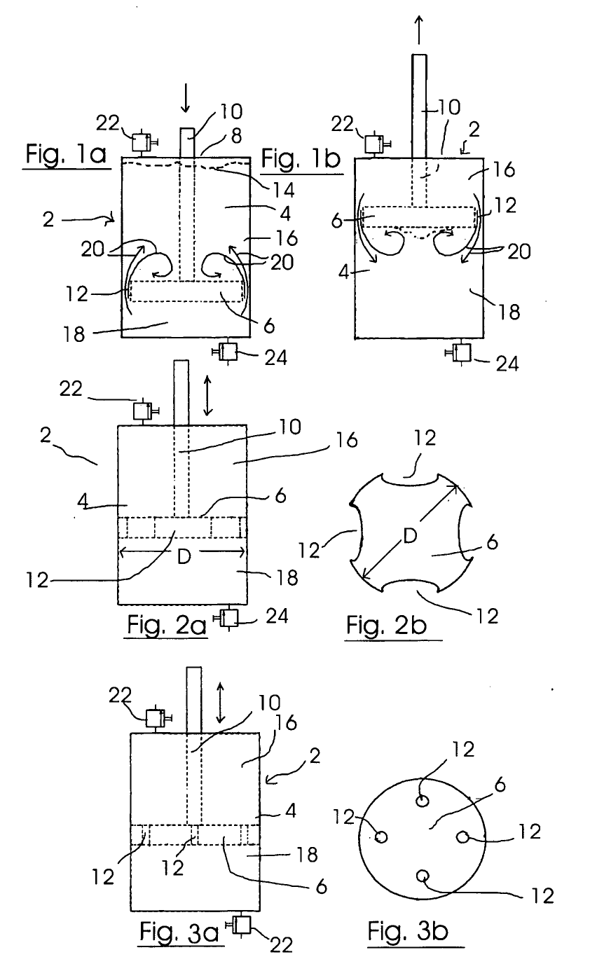

The device for comminuting agglomerates of particles in a suspension according to FIG. 1a and FIG. 1b has a cylinder container 2 in whose cylinder chamber 4 a piston 6 is located such that it can be moved in a reciprocating manner. The piston 6 has a piston rod 10 which is sealingly guided through the upper front end 8 of the cylinder container 2, which piston can be manually operated to axially move the piston 6 to and fro in the cylinder chamber 4. In a variant of the embodiment of FIGS. 1a and 1b a drive motor such as an electric motor can be in a driving connection with the piston rod in order to generate the stroke movements of the piston 6.

The diameter of the piston 6 which is essentially radially centered in FIGS. 1a and 1b is slightly less than the inner diameter of the cylinder chamber 4 such that a small annular gap 12 is present between the piston circumference and the inner circumferential surface of the cylinder chamber 4. This annular gap 12 is a flow path defining a constriction for the suspension 14 held in the cylinder chamber 4. Hence the suspension 14 can flow through the annular gap 12 between the two spatial regions 16 and 18 of the cylinder chamber 4 that are partitioned by the piston 6.

FIG. 1a shows a snapshot of a downwards movement of the piston 6. In this process the piston 6 displaces the suspension from the spatial region 18 through the annular gap 12 into the spatial region 16. The drive force exerted on the piston 6 is of such a magnitude that the suspension fluid passes the constriction 12 at a high flow rate, the flow of the suspension being greatly accelerated immediately before entering the constriction 12. The greatly accelerated elongation flow exerts stretching forces on agglomerates in the suspension that may be present in this area which leads to a break up of the agglomerates.

As shown by the flow arrows 20 that are drawn as a simplified qualitative representation of the flow behavior, the high flow rate of the suspension when it enters the expanding spatial region 16 generates turbulence. This has a mixing effect and contributes to the desired homogenization of the suspension.

FIG. 1b shows a snapshot as the piston 6 is moved upwards during which the suspension 14 is displaced from the spatial region 16 which is now contracting through the constriction 12 into the expanding spatial region 18. On entry and passage through the annular gap 12, agglomerates that may be present in the suspension are subjected to the aforementioned stretching forces in the accelerated elongation flow.

Once the suspension 14 is sufficiently finally dispersed after an appropriate number of axial reciprocating movements of the piston 6, the check valve 22 located in an outlet line can be opened in order to provide the suspension for the intended further use.

24 refers to a check valve in a line leading to the cylinder 2. After this check valve 24 is opened, new suspension can thus be fed into the cylinder chamber 4 for treatment in the device according to the invention.

Elements which correspond to functional or/and constructional elements of the first embodiment are labeled with the same reference numerals in order to elucidate the other embodiments of the invention in the relevant figures.

The second embodiment of the invention according to FIG. 2a and FIG. 3a only differs from the first embodiment in that the piston 6 of the second embodiment has a larger diameter D such that it is slidingly guided directly on the inner wall of the cylinder chamber 4 during its axial reciprocating movement. As shown in particular in FIG. 2b, the piston 6, however, has radial and axial through-grooves 12 which together with the inner wall of the cylinder chamber 4 form a narrowed flow path for the suspension as it is forced to flow backwards and forwards between the spatial regions 16 and 18 by the reciprocating movement of the piston 6.

The third embodiment of FIG. 3a and FIG. 3b is also a modification of the first embodiment which was already elucidated with reference to FIGS. 1a and 1b. In the third embodiment the circumferential wall of the piston 6 is slidingly guided against the inner wall of the cylinder chamber 4. Axial through-holes 12 in the piston 6 serve as a flow path for the suspension when it is displaced between the two spatial regions 16 and 18. In the example of FIG. 3b four through-holes 12 are shown. Of course fewer through-holes can be present depending on the particular application.

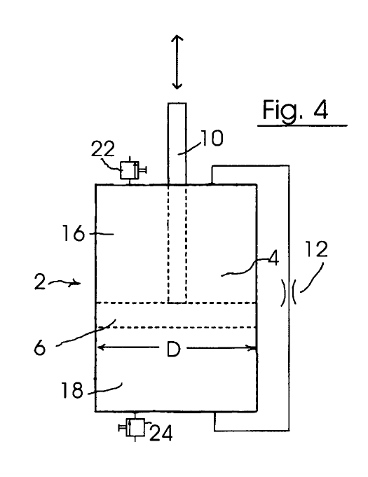

The fourth embodiment of FIG. 4 has a piston 6 which essentially sealingly separates the two spatial regions 16 and 18 from one another. An external fluid line 12 which connects the spatial regions 16 and 18 of the cylinder chamber 4 is provided as a flow path with a constriction or large flow resistance.

1. A device for comminuting agglomerates of particles in a suspension, comprising:
(a) a container for receiving the suspension, wherein the container comprises two spatial regions of a hollow space arrangement, the two spatial regions being connected together by at least one flow path for the suspension which defines a constriction; and
(b) at least one fluid displacement means which can be moved in the container to move a suspension between the two spatial regions.

2. The device for comminuting agglomerates of claim 1, wherein the fluid displacement means is a piston forming a border between the spatial regions which can be moved axially backwards and forwards in a cylinder chamber containing the two spatial regions, wherein said piston can displace the suspension alternately from one spatial region into the other spatial region through the constriction as it moves backwards and forwards in the cylinder chamber.

3. The device for comminuting agglomerates of claim 2, wherein the flow path defining the constriction is formed by an axial through-hole in the piston.

4. The device for comminuting agglomerates of claim 2, wherein the flow path defining the constriction is formed by a gap between a circumferential wall of the piston and a wall of the cylinder chamber.

5. The device for comminuting agglomerates of claim 4, wherein the gap is an annular gap around the circumferential wall of the piston.

6. The device for comminuting agglomerates of claim 4, wherein the gap is formed by a radial recess in the circumferential wall of the piston.

7. The device for comminuting agglomerates of claim 2, wherein the two spatial regions are connected together by a fluid line forming the flow path of the suspension which runs outside the cylinder chamber.

8. The device for comminuting agglomerates of any one of claims 1-7, further comprising a drive motor for a reciprocating movement of the fluid displacement means.

9. The device for comminuting agglomerates of any one of claims 1-7, wherein the fluid displacement means can be manually moved within the container.

10. The device for comminuting agglomerates of any one of claims 1-7, wherein the device is integrated into an automated analytical system for chemical analysis of molecules.

11. A method for comminuting agglomerates of particles present in a suspension comprising:
(a) providing a container according to claim 1;
(b) introducing the suspension containing the particles into the container; and
(c) moving the suspension between the two spatial regions using the fluid displacement means, wherein the movement comminutes agglomerates of particles present in the suspension.
